(19) United States
(12) Patent Application Publication
(10) Pub. No.: US 2025/0245892 A1
(43) Pub. Date: Jul. 31, 2025

(54) SYSTEMS AND METHODS FOR CONSTRUCTING CUSTOM PHOTOS BASED ON SKELETAL FEATURE POINT INPUT

(71) Applicant: Perfect Mobile Corp., New Taipei City (TW)

(72) Inventors: Yi-Wei LIN, New Taipei City (TW); Yi An LEE, Taipei City (TW)

(21) Appl. No.: 19/032,713

(22) Filed: Jan. 21, 2025

Related U.S. Application Data
(60) Provisional application No. 63/625,453, filed on Jan. 26, 2024.

(51) Int. Cl. G06T 11/60; G06T 5/77; G06T 7/50; G06T 7/70; G06V 40/16

(52) U.S. Cl. CPC G06T 11/60; G06T 5/77; G06T 7/50; G06T 7/70; G06V 40/174; G06T 2207/20081

(57) ABSTRACT

A computing device obtains an input image depicting at least one individual. A target image depicting a target individual is obtained. A location within the input image for inserting the target individual is also obtained. The computing device determines attributes of the at least one individual depicted in the input image and synthesizes a replicate of the target individual based on the attributes of the at least one individual. The synthesized replicate of the target individual is inserted into the input image based on the location to generate a modified image.

### CROSS-REFERENCE TO RELATED APPLICATION

This application claims priority to, and the benefit of, U.S. Provisional Patent Application entitled, “AI Group Photo,” having Ser. No. 63/625,453, filed on Jan. 26, 2024, which is incorporated by reference in its entirety.

### TECHNICAL FIELD

The present disclosure generally relates to systems and methods for constructing custom photos based on skeletal feature point input.

### SUMMARY

In accordance with one embodiment, a computing device obtains an input image depicting at least one individual. The computing device obtains a target image depicting a target individual. The computing device also obtains a location within the input image for inserting the target individual. The computing device determines attributes of the at least one individual depicted in the input image and synthesizes a replicate of the target individual based on the attributes of the at least one individual. The synthesized replicate of the target individual is inserted into the input image based on the location to generate a modified image.

Another embodiment is a system that comprises a memory storing instructions and a processor coupled to the memory. The processor is configured to obtain a target image depicting a target individual. The processor is configured to also obtain a location within the input image for inserting the target individual. The processor is configured to determine attributes of the at least one individual depicted in the input image and synthesize a replicate of the target individual based on the attributes of the at least one individual. The synthesized replicate of the target individual is inserted into the input image based on the location to generate a modified image.

Another embodiment is a non-transitory computer-readable storage medium storing instructions to be executed by a computing device. The computing device comprises a processor, wherein the instructions, when executed by the processor, cause the computing device to obtain a target image depicting a target individual. The processor is further configured by the instructions to obtain a location within the input image for inserting the target individual. The processor is further configured by the instructions to determine attributes of the at least one individual depicted in the input image and synthesize a replicate of the target individual based on the attributes of the at least one individual. The synthesized replicate of the target individual is inserted into the input image based on the location to generate a modified image.

Other systems, methods, features, and advantages of the present disclosure will be apparent to one skilled in the art upon examining the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure are better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device configured to construct custom photos based on skeletal feature point input according to various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for constructing custom photos based on skeletal feature point input according to various embodiments of the present disclosure.

FIG. 4 illustrates an example user interface provided on a display of the computing device of FIG. 1 whereby an initial image is displayed to the user according to various embodiments of the present disclosure.

FIG. 5 illustrates an example initial image with a graphical control element for specifying skeletal feature points of the according to various embodiments of the present disclosure.

FIG. 6 illustrates manipulation of the graphical control element of FIG. 5 to define skeletal feature points according to various embodiments of the present disclosure.

FIG. 7 illustrates another example whereby an image is synthesized by the computing device of FIG. 1 based on manipulation of the graphical control element according to various embodiments of the present disclosure.

FIG. 8 illustrates another example user interface provided on a display of the computing device of FIG. 1 whereby the user interface includes a toolbar for selecting a pre-defined pose according to various embodiments of the present disclosure.

FIG. 9 is a top-level flowchart illustrating examples of functionality implemented as portions of the computing device of FIG. 1 for constructing custom photos according to alternative embodiments of the present disclosure.

### DETAILED DESCRIPTION

The subject disclosure is now described with reference to the drawings, where like reference numerals are used to refer to like elements throughout the following description. Other aspects, advantages, and novel features of the disclosed subject matter will become apparent from the following detailed description and corresponding drawings.

Embodiments are disclosed for customizing photos using synthesized images of individuals based on skeletal feature point input. Customized photos are constructed by adding system-generated images of individuals into user-provided photos, thereby allowing a user to customize photos depicting individuals selected by the user. Embodiments are disclosed for allowing users to specify the location, pose, emotion, expression, etc. of the system-generated images of individuals using skeletal feature point input, textual input, and/or other forms of input.

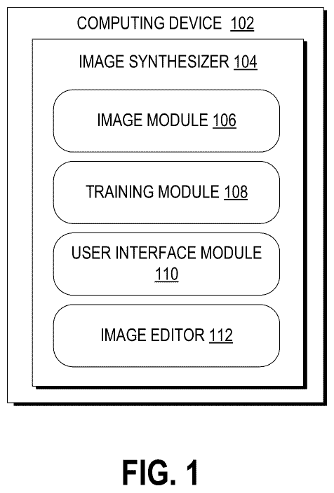

A description of a system for constructing custom photos is described followed by a discussion of the operation of the components within the system. FIG. 1 is a block diagram of a computing device 102 in which the embodiments disclosed herein may be implemented. The computing device 102 may comprise one or more processors that execute machine executable instructions to perform the features described herein. For example, the computing device 102 may be embodied as a computing device such as, but not limited to, a smartphone, a tablet-computing device, a laptop, and so on.

An image synthesizer 104 executes on a processor of the computing device 102 and includes an image module 106, a training module 108, a user interface module 110, and an image editor 112. The image module 106 is configured to obtain an initial image whereby one or more synthesized images of designated or target individuals are later inserted into the image to generate a customized photo. The initial image may be obtained by the image module 106 using, for example, a camera of the computing device 102. The computing device 102 may also be equipped with the capability to connect to the Internet, and the image module 106 may be configured to obtain an initial image or video from another device or server.

The initial images captured or obtained by the image module 106 may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats. The video may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats.

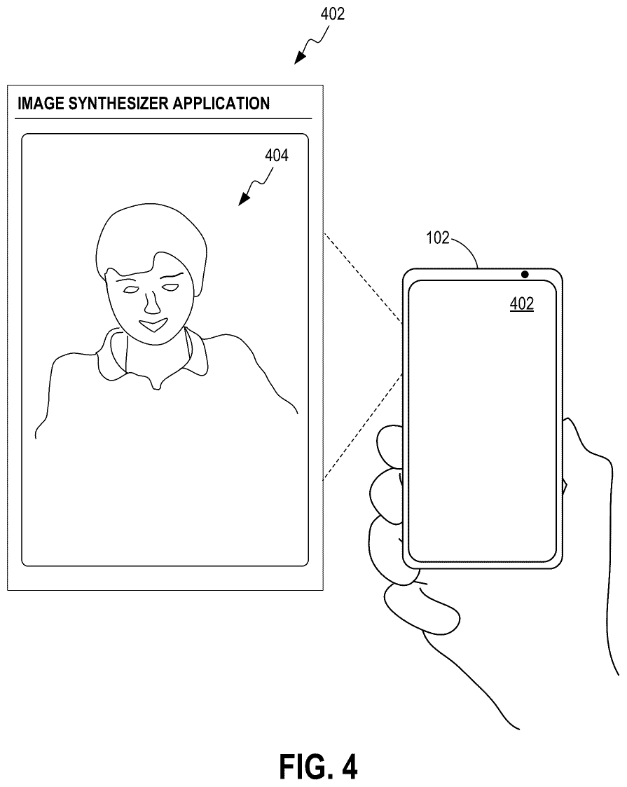

To further illustrate operation of the image module 106, reference is made to FIG. 4, which shows an example user interface 402 provided on a display of the computing device 102 whereby an initial image 404 of an individual is obtained and displayed to the user. As described in more detail below, synthesized images of other target individuals are later inserted in the initial image 404 to create a customized image. For some implementations, the image module 106 (FIG. 1) executing in the computing device 102 is configured to cause a camera of the computing device 102 to capture an initial image 404 or video for purposes of generating, for example, a customized group photo. As discussed earlier, the computing device 102 may also be equipped with the capability to connect to the Internet, and the image module 106 may be configured to obtain an initial image 404 or video of the user from another device or server.

The image module 106 is also executed to obtain reference photos that depict a designated or target individual to be inserted into the initial image 404. The reference photos may depict the target individual in different settings, poses, lighting environments, and so on. The reference photos may also depict the target individual exhibiting different expressions, emotions, clothing, and so on. Note that such attributes (e.g., pose, emotion) may be captured as contextual information stored with the reference photos. Additional contextual information (e.g., image background) may also be specified by the user using textual input obtained by the computing device 102 or selected by use of artificial intelligence.

Referring back to FIG. 1, the training module 108 is executed by the processor of the computing device 102 to receive the reference photos obtained by the image module 106 and train a diffusion model utilized by the training module 108 for generating one or more images of the designated (target) individual depicted in the reference photos. The diffusion model is trained based on the attributes described above associated with the designated individual depicted in the reference photos. A larger volume of reference photos processed by the training module 108 helps to ensure that a more accurate depiction of the designated individual is synthesized for purposes of inserting the synthesized image of the designated individual into the initial image.

The user interface module 110 is configured to display the initial image 404 (FIG. 4) to the user. For some embodiments, a graphical control element with adjustable joints is inserted into the initial image 404 to facilitate input of the desired pose, orientation, and so on. In particular, the graphical control element with adjustable joints allows the user to manipulate skeletal feature points of the graphical control element to define the location, pose, gesture, and so on depicted by the designated individual in the custom image.

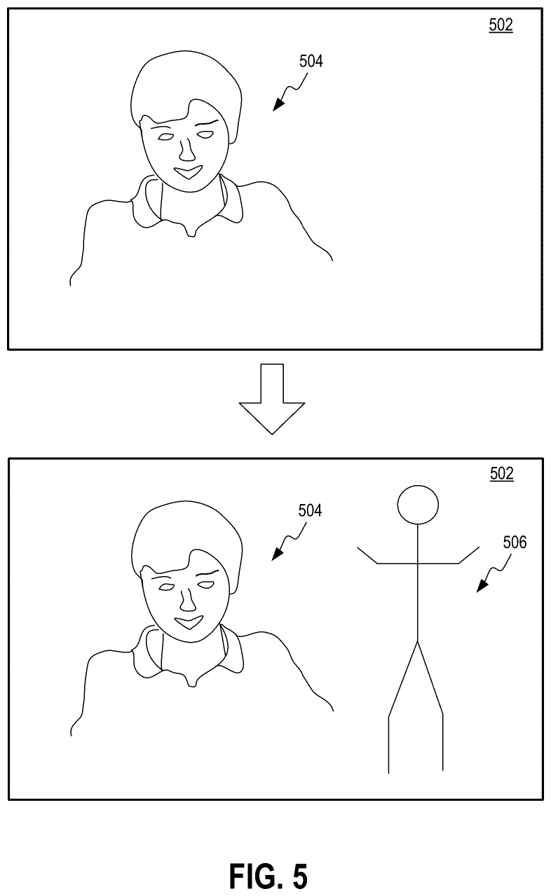

To illustrate, reference is made to the example initial image 502 depicted in FIG. 5. In the example shown, an individual 504 is depicted in the initial image 502. As discussed above, the initial image 502 may be captured by a camera of the computing device 102 (FIG. 1). Alternatively, the initial image 502 may be obtained by the computing device 102 from another device over a network.

For purposes of illustration, assume that the user wishes to insert an image of another individual next to the individual 504 originally depicted in the initial image 502. The user specifies that one designated or target individual will be added into the initial image 502 via the user interface, and this causes the user interface module 110 (FIG. 1) to display a graphical control element 506 corresponding to the individual designated by the user. If the user elects to add more than one individual into the initial image 502, a separate graphical control element 506 is inserted for each individual by the user interface module 110, thereby allowing the user to separately customize the location, orientation, pose, etc. of each individual using a corresponding graphical control element 506.

For some embodiments, the graphical control element 506 is placed in a default location of the initial image 502 based on the location of the individual 504 originally depicted in the initial image 502. Similarly, the initial size, orientation, posture, etc. of the graphical control element 506 may be set according to default values. The default values may be set according to the number of individuals originally depicted in the initial image 502 as well as the number of individuals designated by the user to be inserted into the initial image 502. However, other criteria may be applied in setting the default values.

The user interface module 110 is further configured to detect manipulation of the graphical control element 506. In exemplary embodiments, the graphical control element 506 comprises a skeleton control element with adjustable joints corresponding to various joints of the human body. The adjustable joints may correspond, for example, to ball-and-socket joints (e.g., shoulder, hip joints), hinge joints (e.g., fingers, knees, elbows), and so on. By manipulating the adjustable joints, the user is able to precisely define a desired pose, orientation, gesture, etc. for the corresponding individual. The user may also move the skeleton control element to a desired location in the initial image 502. Similarly, the user may zoom in or out of the skeleton control element so that either a portion of the corresponding individual or the entire body of the individual is depicted in the image. The user may manipulate the adjustable joints and the location of the skeletal control element using a mouse, touchscreen interface, and/or other input device.

Referring back to FIG. 1, the image editor 112 is configured to synthesize an image of the designated or target individual based on the reference photos obtained by the training module 108 to train a diffusion model utilized by the training module 108. Specifically, the image editor 112 is configured to synthesize an image of the designated individual based on the reference photos and based on manipulation of the skeleton control element corresponding to the target individual. For some embodiments, the image editor 112 synthesizes a replicate of the designated individual based on the attributes exhibited by the individual originally depicted in the initial image. Such attributes may include, for example, emotion exhibited by the individual in the initial image, a gaze of the individual, a pose of the individual, a body shape of the individual, clothing worn by the individual, accessories worn by the individual, and/or environmental lighting depicted in the input image. The image editor 112 then renders the synthesized image of the designated individual in the image to generate a customized image comprising the individual originally depicted in the initial image and the individual designated by the user to be inserted into the initial image.

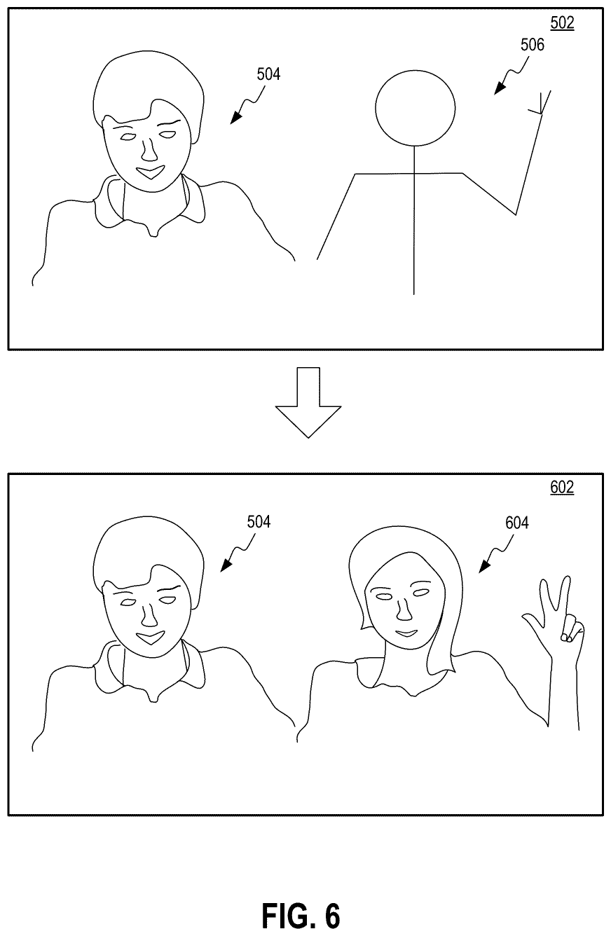

To further illustrate, reference is made to FIG. 6, which illustrates the individual 504 originally depicted in the initial image 502 of FIG. 5 and the graphical control element 506 comprising a skeleton control element with adjustable joints. In the example shown, the user has elected to zoom into the skeleton control element so that only the upper portion of the skeleton control element is shown in the initial image 502. The user has also manipulated the adjustable joints of the skeleton control element to depict the skeleton control element performing a desired gesture. Note that for some embodiments, the user may also specify the desired location, pose, expression etc. of the designated individual using textual descriptors (e.g., “show individual waving hello”).

Once the user has submitted the skeletal feature point input, the training module 108 (FIG. 1) utilizes the diffusion model to synthesize an image of the individual designated 604 by the user to be depicted in the image. The diffusion model generates an image of the individual 604 depicting the same gesture defined in the skeletal feature point input entered by the user. Similarly, the diffusion model generates an image 602 based on the portion of the skeleton control element selected by the user to be depicted in the image (e.g., upper body portion). For some embodiments, the diffusion model also generates an image 602 based on such attributes as emotion exhibited by the individual 504 originally depicted in the initial image 502 of FIG. 5. Other attributes may include an expression of the individual, a gaze of the individual, a pose of the individual, a body shape of the individual, clothing worn by the individual, accessories worn by the individual, and/or environmental lighting depicted in the input image.

In the example shown in FIG. 6, the image editor 112 (FIG. 1) renders the synthesized image 604 of the target individual whereby the emotion (e.g., happiness) or expression (e.g., smile) exhibited by the target individual in the image 604 mirrors the emotion exhibited by the individual 504 originally depicted in the initial image 502 of FIG. 5. As shown, a modified image 602 depicting both the individual 504 originally shown in the initial image 502 and the designation individual is generated.

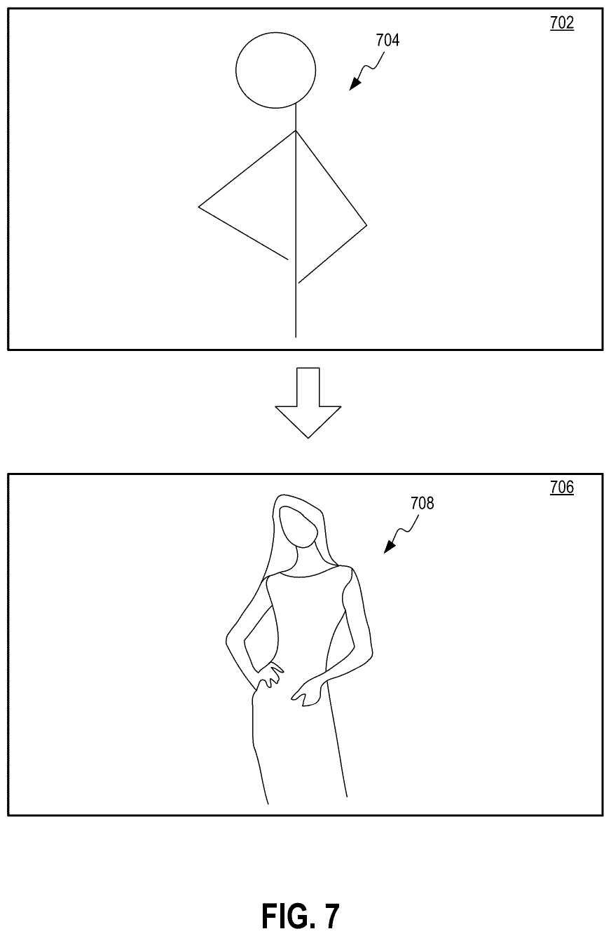

FIG. 7 illustrates another example whereby an image is synthesized by the computing device of FIG. 1 based on manipulation of the graphical control element. In the example shown, assume that the user wishes to insert an individual into the initial image 702 with the individual depicting a particular pose. The user manipulates the graphical control element 704 comprising a skeleton control element with adjustable joints. In this example, the head region of the skeleton control element is shown in a tilted position. Furthermore, the arms are bent with the hands resting around the mid-region of the skeleton control element. The user enters this skeletal feature point input, and the image editor 112 (FIG. 1) and the training module 108 (FIG. 1) execute in conjunction to synthesize an image 708 of the designated individual based on both the manipulation of the skeleton control element and reference photos provided to the training module 108 depicting the designated individual. The synthesize image 708 is shown in the resulting modified image 706.

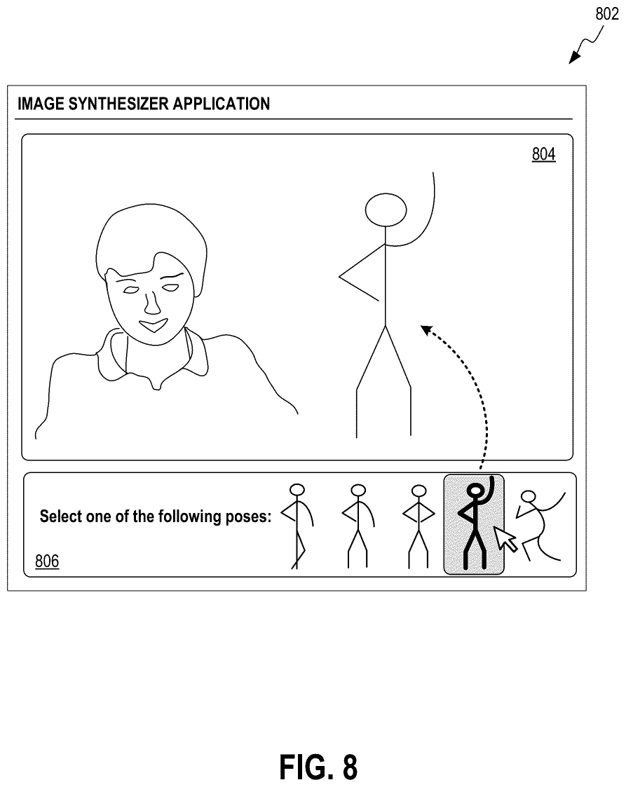

FIG. 8 illustrates another example user interface 802 provided on a display of the computing device of FIG. 1 whereby the user is able to select a pre-defined pose according to various embodiments of the present disclosure. In the example user interface 802, an initial image 804 is shown whereby the user wishes to insert a designated individual into the initial image 804. As described above, the user can manually adjust the joints of the graphical control element comprising a skeleton control element. Alternatively, the user may select one of a series of pre-defined poses from the toolbar 806 shown in the user interface 802. The selected pose will then be used to synthesize an image of the designated individual.

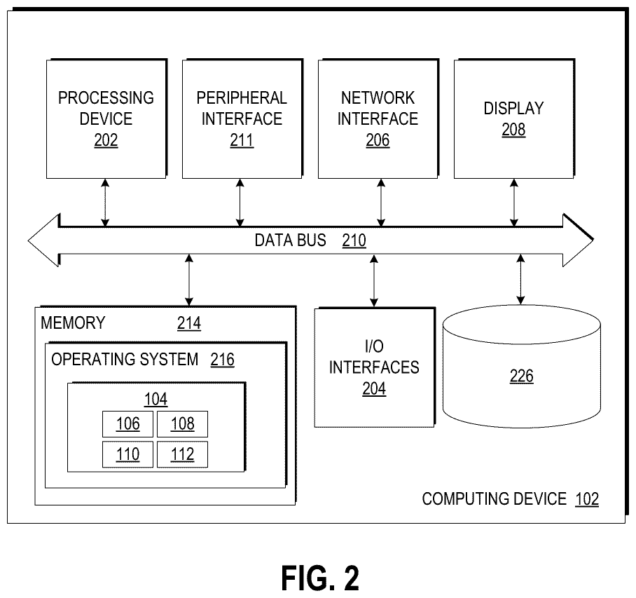

FIG. 2 illustrates a schematic block diagram of the computing device 102 in FIG. 1. The computing device 102 may be embodied as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the computing device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM) such as DRAM and SRAM) and nonvolatile memory elements (e.g., ROM, hard drive, tape, CDROM). The memory 214 typically comprises a native operating system 216, one or more native applications, emulation systems, or emulated applications for any of a variety of operating systems and/or emulated hardware platforms, emulated operating systems, etc. For example, the applications may include application specific software that may comprise some or all the components of the computing device 102 displayed in FIG. 1.

In accordance with such embodiments, the components are stored in memory 214 and executed by the processing device 202, thereby causing the processing device 202 to perform the operations/functions disclosed herein. For some embodiments, the components in the computing device 102 may be implemented by hardware and/or software.

Input/output interfaces 204 provide interfaces for the input and output of data. For example, where the computing device 102 comprises a personal computer, these components may interface with one or more input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

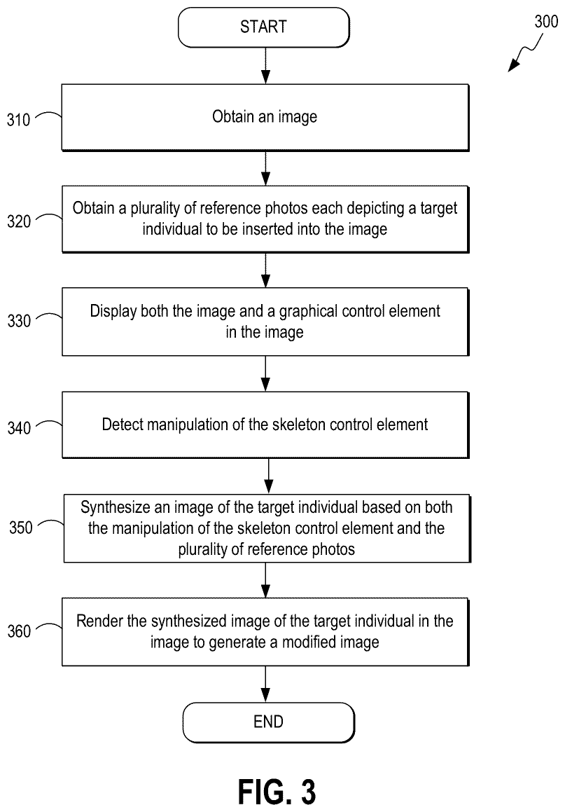

Reference is made to FIG. 3, which is a flowchart 300 in accordance with various embodiments for constructing custom photos based on skeletal feature point input, where the operations are performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. In addition, two or more blocks shown in succession in FIG. 3 may be executed concurrently or with partial concurrence. It is understood that all such variations are within the scope of the present disclosure.

At block 310, the computing device 102 obtains an image and at block 320, the computing device 102 obtains reference photos that each depict a designated individual to be inserted into the image. Each of the reference photos depicts the facial region of the designated individual to be inserted into the image. The computing device 102 utilizes the reference photos to train a diffusion model.

At block 330, the computing device 102 displays a graphical control element in the image where the graphical control element comprises a skeleton control element with adjustable joints. At block 340, the computing device 102 detects manipulation of the skeleton control element where manipulation of the skeleton control element defines the position of the skeleton control element at a specific location in the image, a pose of the of the skeleton control element depicted in the image based on manipulation of the adjustable joints, and/or a gesture performed by the skeleton control element depicted in the image based on manipulation of the adjustable joints.

At block 350, the computing device 102 synthesizes an image of the designated individual based on both the manipulation of the skeleton control element and the reference photos each depicting the designated individual. For some embodiments, the computing device 102 also obtains textual input that defines the position of the skeleton control element at a specific location in the image, the pose of the of the skeleton control element depicted in the image, and/or the gesture performed by the skeleton control element. In such embodiments, the computing device 102 synthesizes the image of the designated individual based on the textual input.

The height of the designated individual is adjusted based on the heights of other individuals depicted in the image. Similarly, a perspective of the designated individual relative to other individuals depicted in the image is adjusted. The lighting of the designated individual is adjusted based on environmental lighting depicted in the image.

At block 360, the computing device 102 renders the synthesized image of the designated individual in the image to generate a modified image. Thereafter, the process in FIG. 3 ends.

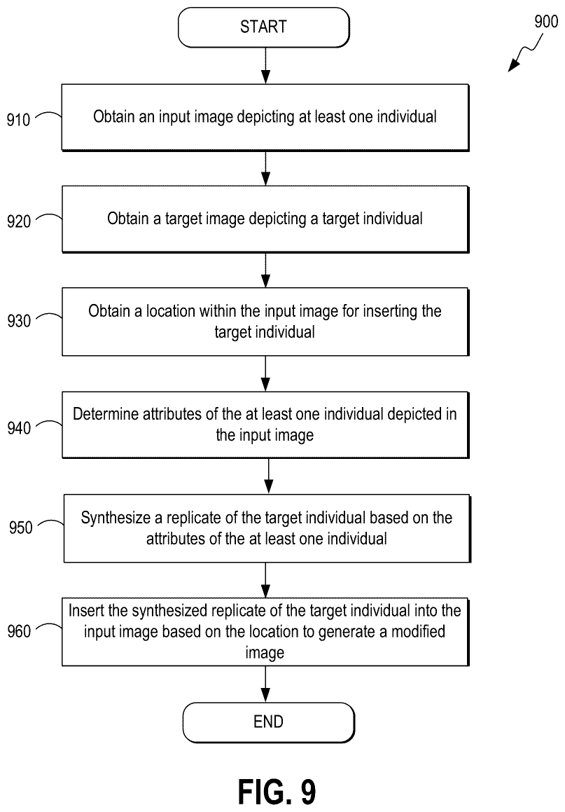

Reference is made to FIG. 9, which is a flowchart 900 in accordance with alternative embodiments for constructing custom photos, where the operations are performed by the computing device 102 of FIG. 1. It is understood that the flowchart 900 of FIG. 9 provides merely an example of the different types of functional arrangements that may be employed to implement the operation of the various components of the computing device 102. As an alternative, the flowchart 900 of FIG. 9 may be viewed as depicting an example of steps of a method implemented in the computing device 102 according to one or more embodiments.

Although the flowchart 900 of FIG. 9 shows a specific order of execution, it is understood that the order of execution may differ from that which is displayed. For example, the order of execution of two or more blocks may be scrambled relative to the order shown. In addition, two or more blocks shown in succession in FIG. 9 may be executed concurrently or with partial concurrence. It is understood that all such variations are within the scope of the present disclosure.

At block 910, the computing device 102 obtains an input image depicting at least one individual. At block 920, the computing device 102 obtains a target image depicting a target individual. At block 930, the computing device 102 obtains a location within the input image for inserting the target individual. For some embodiments, the computing device 102 automatically determines whether to insert the target individual to the right or to the left of the at least one individual in the input image.

At block 940, the computing device 102 determines attributes of the at least one individual depicted in the input image. For some embodiments, the attributes of the at least one individual depicted in the input image includes an expression of the at least one individual, a gaze of the at least one individual, a pose of the at least one individual, a body shape of the at least one individual, clothing worn by the at least one individual, accessories worn by the at least one individual, and/or environmental lighting depicted in the input image. The attributes of the at least one individual may also include contextual details depicted in the input image and emotions depicted in the input image. For some embodiments, the contextual details and emotions are specified using textual input.

At block 950, the computing device 102 synthesizes a replicate of the target individual based on the attributes of the at least one individual. For some embodiments, the computing device 102 synthesizes a replicate of the target individual by training a diffusion model using the target image each depicting the target individual and based on at least one of the attributes of the at least one individual depicted in the input image. The computing device 102 then performs inpainting on a region in the input image using the diffusion model based on the location to fill in the region in the input image with the replicate of the target individual and to mirror at least one of the attributes of the at least one individual depicted in the input image in the replicate of the target individual.

At block 960, the computing device 102 inserts the synthesized replicate of the target individual into the input image based on the location to generate a modified image. Thereafter, the process in FIG. 9 ends.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are included herein within the scope of this disclosure and protected by the following claims.

At least the following is claimed:

1. A method implemented in a computing device, comprising:
obtaining an input image depicting at least one individual;
obtaining a target image depicting a target individual;
obtaining a location within the input image for inserting the target individual;
determining attributes of the at least one individual depicted in the input image;
synthesizing a replicate of the target individual based on the attributes of the at least one individual; and
inserting the synthesized replicate of the target individual into the input image based on the location to generate a modified image.

2. The method of claim 1, wherein obtaining the location within the input image for inserting the target individual further comprises automatically determining whether to insert the target individual to the right or to the left of the at least one individual in the input image.

3. The method of claim 1, wherein the attributes of the at least one individual depicted in the input image comprise at least one of: an expression of the at least one individual, a gaze of the at least one individual, a pose of the at least one individual, a body shape of the at least one individual, clothing worn by the at least one individual, accessories worn by the at least one individual, or environmental lighting depicted in the input image.

4. The method of claim 3, wherein the attributes of the at least one individual depicted in the input image further comprise at least one of: contextual details depicted in the input image and emotions depicted in the input image.

5. The method of claim 1, wherein synthesizing the replicate of the target individual based on the attributes of the at least one individual comprises:
training a diffusion model using the target image each depicting the target individual and based on at least one of the attributes of the at least one individual depicted in the input image; and
performing inpainting on a region in the input image using the diffusion model based on the location to fill in the region in the input image with the replicate of the target individual and to mirror at least one of the attributes of the at least one individual depicted in the input image in the replicate of the target individual.

6. The method of claim 5, wherein the at least one of the attributes of the at least one individual depicted in the input image being mirrored is specified using textual input or is selected by artificial intelligence.

7. A system, comprising:
a memory storing instructions;
a processor coupled to the memory and configured by the instructions to at least:
obtain an input image depicting at least one individual;
obtain a target image depicting a target individual;
obtain a location within the input image for inserting the target individual;
determine attributes of the at least one individual depicted in the input image;
synthesize a replicate of the target individual based on the attributes of the at least one individual; and
insert the synthesized replicate of the target individual into the input image based on the location to generate a modified image.

8. The system of claim 7, wherein the processor is configured to obtain the location within the input image for inserting the target individual by automatically determining whether to insert the target individual to the right or to the left of the at least one individual in the input image.

9. The system of claim 7, wherein the attributes of the at least one individual depicted in the input image comprise at least one of: an expression of the at least one individual, a gaze of the at least one individual, a pose of the at least one individual, a body shape of the at least one individual, clothing worn by the at least one individual, accessories worn by the at least one individual, or environmental lighting depicted in the input image.

10. The system of claim 9, wherein the attributes of the at least one individual depicted in the input image further comprise at least one of: contextual details depicted in the input image and emotions depicted in the input image.

11. The system of claim 10, wherein the at least one of the attributes of the at least one individual depicted in the input image being mirrored is specified using textual input or is selected by artificial intelligence.

12. The system of claim 7, wherein the processor is configured to synthesize the replicate of the target individual based on the attributes of the at least one individual by:
training a diffusion model using the target image each depicting the target individual and based on at least one of the attributes of the at least one individual depicted in the input image; and
performing inpainting on a region in the input image using the diffusion model based on the location to fill in the region in the input image with the replicate of the target individual and to mirror at least one of the attributes of the at least one individual depicted in the input image in the replicate of the target individual.

13. A non-transitory computer-readable storage medium storing instructions to be implemented by a computing device having a processor, wherein the instructions, when executed by the processor, cause the computing device to at least:
obtain an input image depicting at least one individual;
obtain a target image depicting a target individual;
obtain a location within the input image for inserting the target individual;
determine attributes of the at least one individual depicted in the input image;
synthesize a replicate of the target individual based on the attributes of the at least one individual; and
insert the synthesized replicate of the target individual into the input image based on the location to generate a modified image.

14. The non-transitory computer-readable storage medium of claim 13, wherein the processor is further configured by the instructions to obtain the location within the input image for inserting the target individual by automatically determining whether to insert the target individual to the right or to the left of the at least one individual in the input image.

15. The non-transitory computer-readable storage medium of claim 13, wherein the attributes of the at least one individual depicted in the input image comprise at least one of: an expression of the at least one individual, a gaze of the at least one individual, a pose of the at least one individual, a body shape of the at least one individual, clothing worn by the at least one individual, accessories worn by the at least one individual, or environmental lighting depicted in the input image.

16. The non-transitory computer-readable storage medium of claim 15, wherein the attributes of the at least one individual depicted in the input image further comprise at least one of: contextual details depicted in the input image and emotions depicted in the input image.

17. The non-transitory computer-readable storage medium of claim 16, wherein the at least one of the attributes of the at least one individual depicted in the input image being mirrored is specified using textual input or is selected by artificial intelligence.

18. The non-transitory computer-readable storage medium of claim 13, wherein the processor is further configured by the instructions to synthesize the replicate of the target individual based on the attributes of the at least one individual by:
training a diffusion model using the target image each depicting the target individual and based on at least one of the attributes of the at least one individual depicted in the input image; and
performing inpainting on a region in the input image using the diffusion model based on the location to fill in the region in the input image with the replicate of the target individual and to mirror at least one of the attributes of the at least one individual depicted in the input image in the replicate of the target individual.
